(19) United States
(12) Patent Application Publication
(10) Pub. No.: US 2020/0334626 A1
(43) Pub. Date: Oct. 22, 2020

(54) METHODS AND SYSTEMS FOR DATA QUALITY ANALYSIS OF HEALTHCARE INFORMATION SYSTEMS

(71) Applicant: VIZIENT SUPPLY, LLC, Irving, TX (US)

(72) Inventors: Timothy A. VanderMolen, Lewisville, TX (US); Melanie Polston, Dallas, TX (US)

(21) Appl. No.: 16/921,625

(22) Filed: Jul. 6, 2020

Related U.S. Application Data
(63) Continuation of application No. 14/747,345, filed on Jun. 23, 2015, now abandoned.

(51) Int. Cl. G06Q 10/08; G06Q 10/06

(52) U.S. Cl. CPC G06Q 10/087; G06Q 10/06395

(57) ABSTRACT

Methods, systems, and apparatuses for performing data quality analysis of healthcare information systems are provided. An example of a method includes receiving, via electronic communication with a healthcare organization (HCO) item master database, one or more products available for purchase by the HCO, mapping, using a processor and a set of third-party product data, each of the one or more products to a HCO-agnostic product identifier, identifying at least one duplicate entry within the item master database based at least in part on two or more of the one or more products mapping to the same HCO-agnostic product identifier, generating a user interface indicating the presence of the at least one duplicate entry, and causing the user interface to be provided via a display.

### CROSS REFERENCE

This application is a continuation of U.S. patent application Ser. No. 14/747,345, filed Jun. 23, 2015, the entire contents of which are incorporated by reference.

### TECHNOLOGICAL FIELD

Example embodiments of the present invention relate generally to healthcare information systems and, more particularly, to methods, systems, and apparatuses for providing data quality analysis of healthcare information systems such as electronic item masters and electronic formularies.

### BACKGROUND

The applicant has discovered problems with current methods, systems, and apparatuses for managing electronic healthcare information systems. Through applied effort, ingenuity, and innovation, Applicant has solved many of these identified problems by developing a solution that is embodied by the present invention, which is described in detail below.

### BRIEF SUMMARY

Accordingly, a method, apparatus, and computer program are provided to manage healthcare information systems. Example embodiments may include methods, systems, apparatuses, and the like that provide for data quality analysis of electronic item masters and formularies. In particular, embodiments reconcile product data stored within healthcare information systems with product data indexed in an organization-agnostic format. Embodiments are capable of identifying duplicate records, obsolete data entries, and missing entries from these systems. Embodiments also provide interfaces for viewing and interacting with data stored in such systems. Embodiments also provide for mapping of electronic transaction data to electronic data stored in electronic healthcare information systems to assist with evaluating the impact of changing or updating said electronic healthcare information systems. Embodiments also provide for generation of various metrics and data analysis techniques of data stored in healthcare information systems, along with interfaces and techniques for formatting and presenting said metrics and results of said data analysis techniques.

Example embodiments include an apparatus for performing data quality analysis of healthcare information systems. The apparatus includes healthcare information system interface circuitry configured to receive, via electronic communication with a healthcare organization (HCO) item master database, one or more products available for purchase by the HCO. The apparatus also includes healthcare information system analysis circuitry configured to map, using a set of third-party product data, each of the one or more products to a HCO-agnostic product identifier, identify at least one duplicate entry within the item master database based at least in part on two or more of the one or more products mapping to the same HCO-agnostic product identifier, generate a user interface indicating the presence of the at least one duplicate entry, and cause the user interface to be provided via a display. The healthcare information system analysis circuitry may be configured to receive an indication, via a user interface control of the user interface, to remove the at least one duplicate entry, and cause the healthcare information system interface circuitry to remove the at least one duplicate entry from the item master database. The healthcare information system analysis circuitry may be further configured to identify, using the third-party product data, at least one product of the one or more products no longer available for purchase from at least one supplier, wherein the user interface further indicates the presence of the product no longer available for purchase.

The healthcare information system analysis circuitry may be further configured to generate a data quality score for the item master database derived at least in part based on a number of identified duplicate entries and a number of one or more products no longer available, and provide the data quality score via the user interface. The data quality score may be further based at least in part on a number of products included in the third-party product data but not the item master database. The healthcare information system analysis circuitry may be further configured to receive electronic transaction information for one or more product purchases performed by the HCO, map the electronic transaction information to the one or more products available for purchase, and provide spend data derived from the electronic transaction information via the user interface. The electronic transaction information may be derived by monitoring electronic purchases of products by the HCO from a procurement information system.

Embodiments also include a method for performing data quality analysis of healthcare information systems. The method includes receiving, via electronic communication with a healthcare organization (HCO) item master database, one or more products available for purchase by the HCO, mapping, using a processor and a set of third-party product data, each of the one or more products to a HCO-agnostic product identifier, identifying at least one duplicate entry within the item master database based at least in part on two or more of the one or more products mapping to the same HCO-agnostic product identifier, generating a user interface indicating the presence of the at least one duplicate entry, and causing the user interface to be provided via a display.

The method may include receiving an indication, via a user interface control of the user interface, to remove the at least one duplicate entry, and removing the at least one duplicate entry from the item master database. The method may also include identifying, using the third-party product data, at least one product of the one or more products no longer available for purchase from at least one supplier, wherein the user interface further indicates the presence of the product no longer available for purchase. The method may include generating a data quality score for the item master database derived at least in part based on a number of identified duplicate entries and a number of one or more products no longer available, and providing the data quality score via the user interface. The data quality score may be further based at least in part on a number of products included in the third-party product data but not the item master database. The method may include receiving electronic transaction information for one or more product purchases performed by the HCO, mapping the electronic transaction information to the one or more products available for purchase, and providing spend data derived from the electronic transaction information via the user interface. The electronic transaction information may be derived by monitoring electronic purchases of products by the HCO from a procurement information system.

Embodiments also include a non-transitory computer readable storage medium comprising instructions that, when executed by a processor, cause the processor to perform data quality analysis of a healthcare information system. The instructions cause the processor to receive, via electronic communication with a healthcare organization (HCO) item master database, one or more products available for purchase by the HCO, map, using a processor and a set of third-party product data, each of the one or more products to a HCO-agnostic product identifier, identify at least one duplicate entry within the item master database based at least in part on two or more of the one or more products mapping to the same HCO-agnostic product identifier, generate a user interface indicating the presence of the at least one duplicate entry, and cause the user interface to be provided via a display.

The computer readable storage medium may also include instructions that cause the processor to receive an indication, via a user interface control of the user interface, to remove the at least one duplicate entry, and remove the at least one duplicate entry from the item master database. The computer readable storage medium may also include instructions that cause the processor to identify, using the third-party product data, at least one product of the one or more products no longer available for purchase from at least one supplier, wherein the user interface further indicates the presence of the product no longer available for purchase. The computer readable storage medium may also include instructions that cause the processor to generate a data quality score for the item master database derived at least in part based on a number of identified duplicate entries and a number of one or more products no longer available, and provide the data quality score via the user interface. The data quality score may be further based at least in part on a number of products included in the third-party product data but not the item master database. The computer readable storage medium may also include instructions that cause the processor to receive electronic transaction information for one or more product purchases performed by the HCO, map the electronic transaction information to the one or more products available for purchase, and provide spend data derived from the electronic transaction information via the user interface.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain example embodiments of the present disclosure in general terms, reference will now be made to the accompanying drawings, which are not necessarily drawn to scale, and wherein:

FIG. 1 illustrates an example system within which embodiments of the present invention may operate;

FIG. 2 illustrates a block diagram showing an example device for performing data analysis of one or more healthcare information systems using special-purpose circuitry in accordance with some exemplary embodiments of the present invention;

FIG. 3 illustrates an example data flow among components of a healthcare information analysis system in accordance with some exemplary embodiments of the present invention;

FIGS. 4-10 are illustrations of example interfaces for generating metrics and providing analysis of data stored in a healthcare information system in accordance with some exemplary embodiments of the present invention;

FIG. 11 illustrates a flow diagram depicting an example of a method for analyzing a healthcare item master in accordance with some exemplary embodiments of the present invention; and

FIG. 12 illustrates a flow diagram depicting an example of a method for analyzing a healthcare formulary in accordance with some exemplary embodiments of the present invention.

### DETAILED DESCRIPTION

### Overview

Various embodiments of the present invention are directed to improved apparatuses, methods, and computer readable media for performing data quality analysis of healthcare information systems. In this regard, embodiments of the present invention provide systems, devices, and frameworks that receive, process, and monitor information stored within healthcare information systems, provide mechanisms for viewing and accessing such information, and provide mechanisms for improving the quality of information stored in those healthcare information systems. For example, embodiments may perform programmatic analysis of electronic healthcare formulary systems, electronic item masters, and the like. To perform these functions, embodiments may also monitor electronic transaction information associated with the purchase and sale of products to/from a healthcare organization, and use the monitored electronic transaction information for reconciliation with data stored in other healthcare information systems (e.g., the aforementioned electronic item master and electronic formulary). Embodiments may also provide interfaces for comparing electronic healthcare information system data to data stored in other systems, such as on a healthcare information analysis system located externally to the healthcare information system, which may include electronic information received from a plurality of healthcare organizations.

### Definitions

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As used herein, the terms “data,” “content,” “information,” and similar terms may be used interchangeably to refer to data capable of being transmitted, received, and/or stored in accordance with embodiments of the present invention. Thus, use of any such terms should not be taken to limit the spirit and scope of embodiments of the present invention. Further, where a computing device is described herein to receive data from another computing device, it will be appreciated that the data may be received directly from the another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to the another computing device or may be sent indirectly via one or more intermediary computing devices, such as, for example, one or more servers, relays, routers, network access points, base stations, hosts, and/or the like.

In the context of this application, the term “product” should be understood not only to encompass individual items provided by the supplier, but also sets of items (e.g., several items sold as a group or kit), services (e.g., labor or staffing needs), and various other tangible and intangible goods and services which may be procured according to a supply contract. Examples of these products may include medical supplies and devices, physician preference items, pharmaceuticals, capital, services, and the like.

As used herein, the term “category” should be understood to include particular groupings or organizations of products. Categories may be defined based on the type of product, the intended use of the product, or the like. For example, in the case of medical supplies and devices, products may be identified as belonging to a particular United Nations Standard Products and Services Code (UNSPSC), a “Product Spend Category” as defined by Novation LLC, or various other groupings of products. A category may be a pre-defined collection of one or more, and typically a plurality of, UNSPSCs. Categories may be pre-defined for a particular market ecosystem or may be pre-defined by the market. For example, products may be assigned to particular categories by the functionality of the product (e.g., products that protect the user from a particular hazard), by the construction of the product (e.g., products made of latex), by the intended use of the product (e.g., products used by surgeons during a heart surgery), general industrial knowledge, or by any other set of criteria. These categories may be established by an owner or maintainer of the market platform, or in communication with suppliers and/or buyers of the products. Product associations with particular categories may be mutually exclusive, such that any given product may only be associated with a single category.

Embodiments may also leverage knowledge of pre-defined or programmatically defined “cross-references” between products. As used herein, the term “cross-reference” is generally understood to refer a relationship between products which have the same or similar functional characteristics such that one product may be used in place of the other in a medical context. A “cross-reference” between two products therefore indicates that those products have a functional equivalency with one another. Embodiments may include mechanisms for identifying cross-references from various sources, including based on previous spending data, based on requests generated by users, based on crowd-sourced data, based on information received from remote healthcare information systems, or the like.

In the context of the present application, the use of the term “healthcare information system” is intended to refer to an electronic, computer-implemented system for managing access to healthcare data. Examples of a healthcare information system may include a hospital computer system implementing an electronic item master and electronic formulary, electronic procurement systems, and the like. The term “procurement system” is intended to refer to a specialized subset of healthcare information systems related to the procurement of products for use in a healthcare setting. Example procurement systems include electronic, computer-implemented systems for submitting orders, generating invoices, maintaining item masters, maintaining formularies, maintaining product cross-reference lists, providing payment information, and the like.

In the context of the present application, the use of the term “item master” is understood to refer to electronic healthcare information systems that implement listings of products available to order by a healthcare organization. The use of the term “charge master” is understood to refer to electronic healthcare information systems that implement prices for particular products and services offered by a healthcare organization.

The term “formulary” is understood to refer to an electronic database of products that specify particular pre-approved products for use by a healthcare organization. The term “item master” is a list of all products available for use by the healthcare organization.

### Technical Underpinnings and Implementation of Exemplary Embodiments

Healthcare organizations (HCOs) have been dramatically affected by the decreasing cost and increasing processing power of modem computers. The move toward electronic medical records and electronic ordering and processing has dramatically increased the information available to HCOs about their own operations and those of others in the field. Product orders, which previously would have been filled out by hand and mailed or faxed to sellers, may now be completed electronically through e-commerce interfaces, whether over the Internet or through direct interface with seller systems by HCOs. Formularies, which provide a list of approved products and medications for use by a HCO and/or insurance providers affiliated with the HCO, may be maintained in an electronic form that simplifies ordering of listed products and enables direct interfacing with procurement systems. However, although the use of technology has streamlined some aspects of the ordering of products by HCOs, certain mandatory aspects of HCO ordering systems remain as pain points for users.

In particular, the inventors have realized that current methods, processes, and devices for auditing data stored in electronic healthcare systems are inadequate. In particular, the inventors have identified problems with current techniques for maintaining electronic data stored in electronic healthcare information systems such as electronic formularies and electronic item masters. Prior to the introduction of electronic data storage techniques, review and auditing of such product listings may have been relatively straightforward. In non-electronic, “physical” implementations, addition of a new product to a formulary or item master would be carefully performed periodically as new products were offered or discontinued by manufacturers and approved for use by the HCO/insurers. Although cumbersome to update, by carefully controlling revisions to these lengthy lists of products, such lists were reasonably likely to be accurate for a particular period after such a revision.

With the move to electronic systems, it has become much easier to update these lists by adding and removing products contained therein through the use of electronic interfaces. Adding a new entry for a newly approved product may be as simple as filling out a fillable form and pressing a “submit” key. However, although these electronic systems have resulted in a much more flexible system that is easier to update, the ease of such updates also increases the potential for errors. For example, users may inadvertently create duplicate entries due to typographical errors or incorrect categorization. In other circumstances, products may have incorrect names or model numbers due to data entry errors or changes over time. Since edits may now be performed “on the fly”, one record at a time, a less stringent review process may be employed than in scenarios where a new revision of the document incorporating many changes is propagated.

The inventors have recognized these problems that are inherent to the use of electronic healthcare information systems. To address these issues, the inventors have developed a variety of methods, systems, processes, and devices to assist with error detection, data access, and calculation of metrics for electronic healthcare information systems. These systems leverage the electronic nature of such healthcare information systems to programmatically detect errors and other possibilities for improvement. Some embodiments further leverage an interface with HCO procurement systems (e.g., electronic product invoices and purchase orders) to reconcile purchase data with electronic healthcare information systems. Embodiments also provide for the programmatic analysis of individual records stored healthcare information systems to perform analytics and calculate metrics representing the overall “health” or “data quality” of electronic records stored in those healthcare information systems. Embodiments also provide novel interfaces for viewing, and accessing data stored in such healthcare information systems, and for suggesting additions and improvements based on external data sources such as lists of product cross-references.

Additionally, current healthcare information systems fail to provide interfaces that leverage access to electronic procurement systems to provide metrics and analytics derived from electronic HCO spend data. The inventors have developed novel interfaces that reconcile electronic spend data with electronic formulary systems and electronic item masters to generate spending analytics and other metrics. These systems may, for example, identify expected pricing for products that have cross-references to formulary products, and present analytics to users indicating areas where less expensive cross-references are available for purchase. To perform these functions, the inventors have developed novel techniques for accessing healthcare information systems such as electronic formularies, identifying cross-reference products for products identified in those electronic formularies by interfacing with procurement systems, determining spending on formulary products from electronic spending data obtained from procurement systems, and calculating the cost if the spending for products identified in the electronic formulary was instead diverted to cross-reference products. Some embodiments may also identify what percentage of overall product purchases are made for formulary items and provide such information to users. These embodiments may provide such data for particular products, groups of products, product categories, and the like. It should be appreciated that such analysis techniques require that said data be stored in an electronic format to provide useful data.

By providing mechanisms for analyzing and improving the quality of electronic data stored in electronic healthcare information systems, embodiments both provide for improved performance and functioning of such electronic healthcare information systems and for improved decision-making by users of such systems. For example, identification and removal of duplicate product entries and obsolete/defunct product entries may improve the speed of database accesses, by reducing the number of records to be searched for a given query. The use of novel electronic data interfaces provided between different information systems enables the creation of new metrics and analysis techniques that were previously not possible. Accordingly, embodiments further provide technological improvements to existing healthcare information systems by providing novel electronic interfaces and communication techniques between various healthcare information systems, and, in particular, procurement systems, to provide the functionality described herein.

### System Architecture

Methods, apparatuses, and computer program products of the present invention may be embodied by any of a variety of devices. For example, the method, apparatus, and computer program product of an example embodiment may be embodied by a networked device, such as a server or other network entity, configured to communicate with one or more devices, such as one or more client devices. Additionally or alternatively, computing devices may include fixed computing devices, such as a personal computer or a computer workstation. Still further, example embodiments may be embodied by any of a variety of mobile terminals, such as a portable digital assistant (PDA), mobile telephone, smartphone, laptop computer, tablet computer, or any combination of the aforementioned devices.

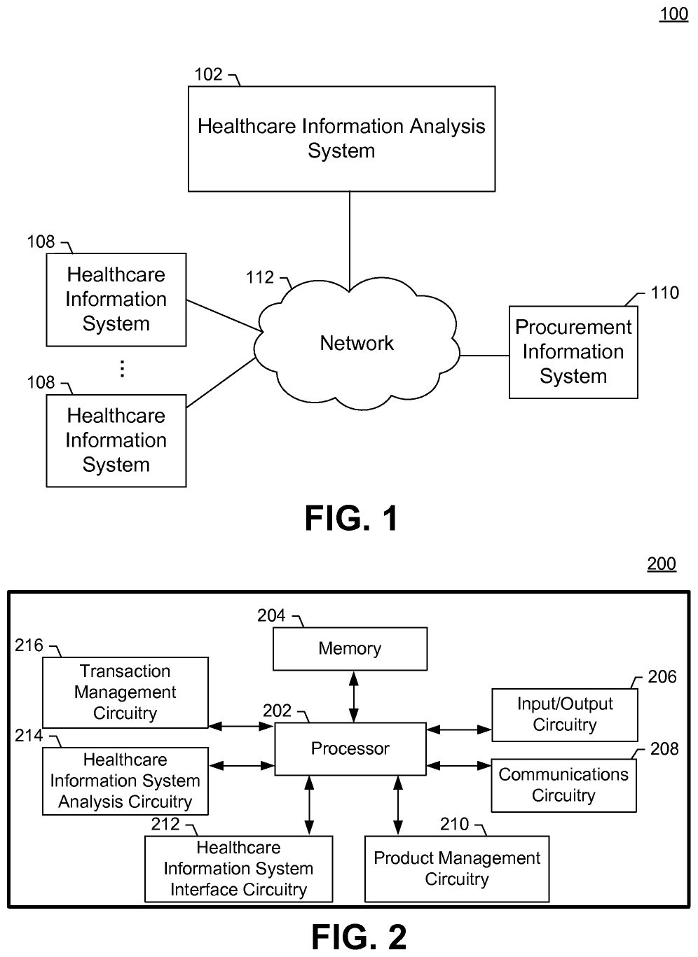

In this regard, FIG. 1 discloses an example computing system within which embodiments of the present invention may operate. Embodiments may include a healthcare information analysis system 102 in communication with one or more healthcare information systems 108 and a procurement information system 110 via a network 112.

The present exemplary embodiment describes a healthcare information analysis system 102 that is separate and distinct from the one or more healthcare information systems 108. The healthcare information analysis system 102 may include a computer or computers as known in the art. For example, the healthcare information analysis system 102 may include one or more servers located at a data center, at a HCO, or the like. Such healthcare information analysis systems 102 may communicate directly or indirectly with such healthcare information systems 108 via a network. For example, an application executing remotely from a healthcare information system or systems may be located at a different data center, such as a data center operated by a third party external to the HCO. For example, the healthcare information analysis system 102 may be an application or applications operated by a procurement service, a supplier, or other party that facilitates the purchasing of products used by HCOs. Such a healthcare information analysis system 102 may provide information and management of change requests via electronic interfaces such as application programming interfaces (APis) and the like. In some embodiments, the healthcare information analysis system 102 may further provide a web or Internet-based “dashboard” interface allowing users to view data, metrics, and analytics related to healthcare information systems such as an electronic item master and an electronic formulary.

In other embodiments, the healthcare information analysis system 102 may be located onsite to the HCO and operated directly by the HCO. For example, the healthcare information analysis system 102 may be implemented as one or more applications or components executing on the same computing node or nodes as the healthcare information system 108.

Regardless of the location at which the healthcare information analysis system 102 is implemented, the healthcare information analysis system may receive data from the healthcare information systems 108 and the procurement information system 110. Data received from the health information systems 108 may include a variety of electronic data related to management of the healthcare information systems 108 and procurement of products by the HCO. For example, the healthcare information analysis system 102 may monitor or otherwise track electronic data relating to the ordering of products by the HCO, such as purchase orders generated by an electronic ordering system operated by the HCO or invoices generated by a supplier computer system. The healthcare information analysis system 102 may identify particular products from electronic order information (e.g., the aforementioned electronic purchase orders and/or invoices) submitted by the HCOs to the healthcare information analysis system 102 via the health information systems 108.

In some embodiments, orders (e.g., electronic purchase orders) are sent from the healthcare information systems 108 to the procurement information system 110, and the procurement information system 110 facilitates processing of the order and shipment of the products. In such embodiments, the healthcare information analysis system 102 may receive a duplicate copy of data sent to the procurement information system 110 in this manner, such that the same data is transmitted to the healthcare information analysis system 102 and the procurement information system 110. In other embodiments, the healthcare information system 110 may be provided with product ordering data by the procurement information system 110 without the healthcare information system 102 having to send a separate copy of the data to the healthcare information analysis system 102, such as by monitoring electronic network traffic between a healthcare information system and the procurement information system 110, or by monitoring electronic network traffic between a supplier computer system (not shown) and the procurement information system 110.

The healthcare information analysis system 102 is operable to analyze data records stored in components of the healthcare information system 108 to generate metrics and analytics for the data stored in the healthcare information system 108. For example, the healthcare information analysis system 102 may analyze electronic formularies and/or item masters to identify errors, redundancies, and the like. In some embodiments, the healthcare information analysis system 102 may use one or more factors to generate a “data quality score”, which is a numeric value derived from factors such as the number of duplicate records detected, the number of obsolete records detected (e.g., records for products that are no longer available for purchase from suppliers), the number of products no longer stocked by the HCO, a number of products identified to be added (e.g., products indicated as available in a third-party product database but which are not referenced in the healthcare information system), a number of products to be removed, and the like. The healthcare information analysis system 102 may also generate metrics related to spending activity as compared to electronic data stored in the healthcare information systems 108, such as the amount of spending on products identified in an item master or formulary as compared to the total amount of spending by the organization, or the like. In some embodiments, a quality of the data stored in the healthcare information system 108 may also be determined using such spending data, such as by assigning a quality score to an electronic formulary based at least in part on the amount of overall spending on formulary items as compared to the total spend by the HCO, with the implication that a HCO with a high quality electronic formulary should expect at least a minimum percentage of total spending to be on formulary products.

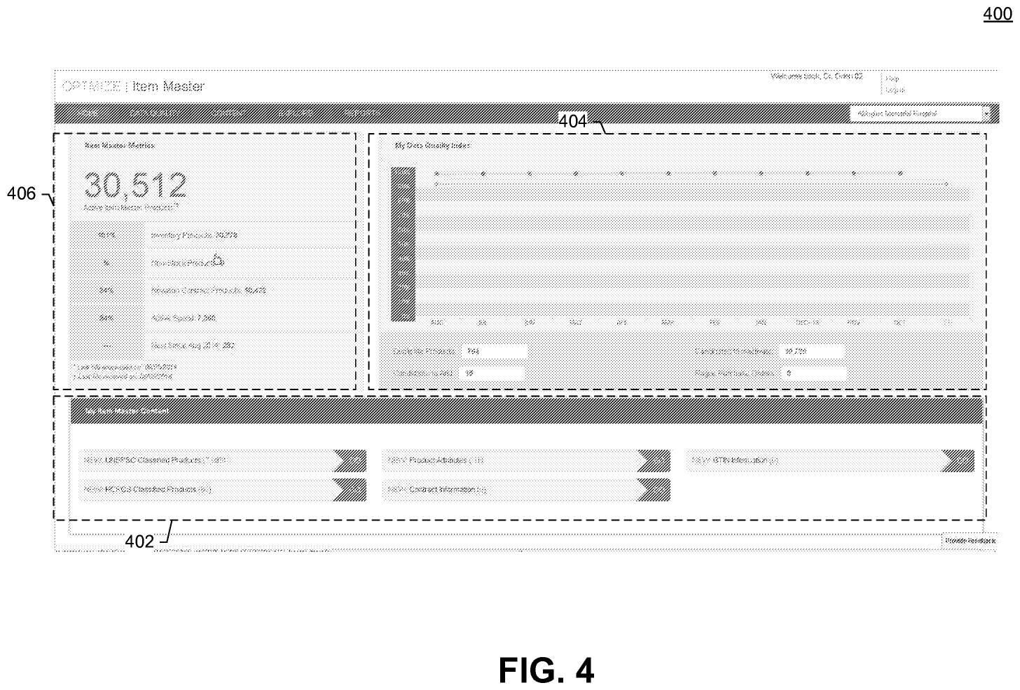

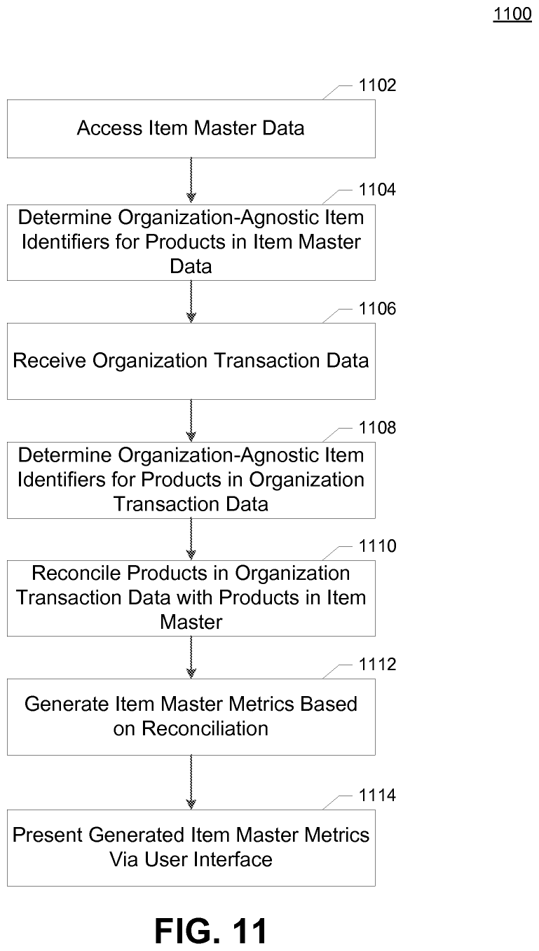

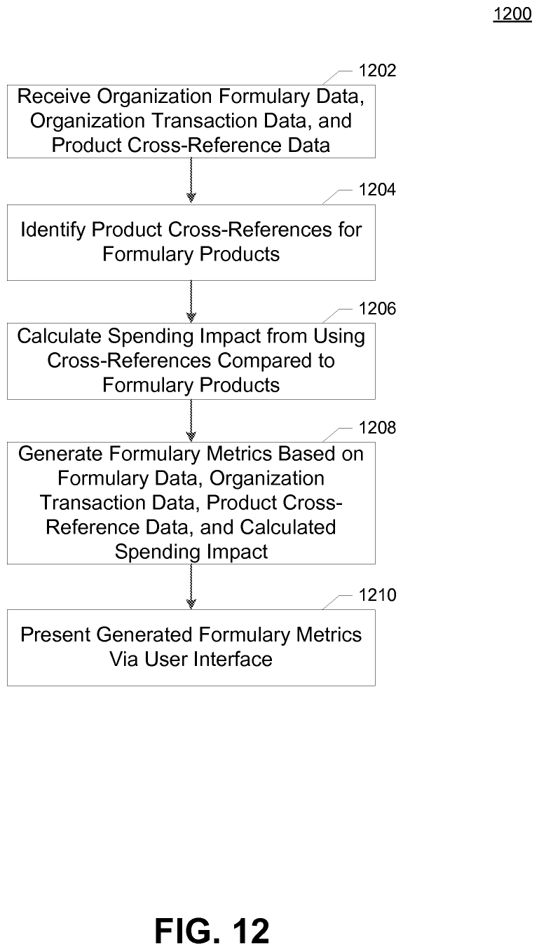

The healthcare information analysis system 102 may also generate metrics related to purchase planning improvement and selection of items for addition to the healthcare information systems 108. For example, embodiments may compare HCO spending data to a set of external product data provided by a procurement system 110 to identify products as candidates to be added or removed from a product formulary. In some embodiments, the healthcare information analysis system 102 may receive product cross-references to products listed in the formulary and perform cost-comparisons using those cross-references. Example interfaces for viewing and accessing results of some example processing performed by the healthcare information analysis system 102 are provided below with respect to FIGS. 4-10. Example processes by which some of these tasks may be implemented are described further below with respect to FIGS. 11-12.

The healthcare information analysis system 102 may perform these functions and other functions in response to a variety of inputs, schedules, or the like. To this end, the healthcare information analysis system 102 may provide interfaces for initiating an analysis of a healthcare information system 108, for scheduling an analysis at a particular interval, or the like. In some embodiments, analysis of the healthcare information systems 108 is provided on an ongoing basis, and metrics and analytics are updated in real-time based on data received from the procurement information system 110 and based on monitoring of the healthcare information systems 108.

Data provided by the healthcare information systems 108 may include, without limitation, product descriptions, manufacturer names, manufacturer catalog numbers, vendor names, vendor catalog numbers, prices paid, purchase order counts, and/or the like. Such information may be provided from or as part of data stored in an electronic formulary or item master, derived from purchase orders or other spend history associated with the HCO, or the like.

The healthcare information systems 108 may include electronic systems associated with one or more HCOs. It should be appreciated that some HCOs may include multiple separate entities that pool together product purchases. For example, a single HCO entity from a procurement perspective may include multiple hospitals, clinics, or the like. In some embodiments, each of these disparate entities may have a separate healthcare information system 108 that interacts with the healthcare information analysis system 102. The healthcare information analysis system 102 may thus be associated only with an entity or entities related to a particular HCO, such that the particular HCO has its own installation of the healthcare information analysis system 102.

Alternatively, in some embodiments the healthcare information analysis system 102 may be associated with a plurality of separate HCOs that are otherwise unrelated. In such embodiments, the healthcare information analysis system 102 may be implemented by a third party entity (e.g., a procurement provider) for the benefit of the HCOs in making purchases via the third party entity. In yet further embodiments, a third party may implement the healthcare information analysis system 102 and charge for access to the healthcare information system 102, such as by charging a subscription, a one-time fee, or the like.

The healthcare information systems 108 may include a variety of healthcare system components, including but not limited to an item master, a formulary, a charge master, and/or the like. The healthcare information systems 108 may provide the healthcare information analysis system 102 with a mechanism to make changes to the healthcare information systems 108, such as via an API, via direct access to files containing product data, or the like.

The procurement information system 110 includes data relating to particular products that may be purchased by a HCO. In particular, the procurement information system 110 may include a list of products offered by suppliers that are associated with a procurement system that offers the procurement information system 110. The procurement information system 110 may include or be implemented in conjunction with a system that allows HCOs to purchase products from suppliers via an electronic interface. In some embodiments, the entity operating the procurement information system 110 may also operate the healthcare information analysis system 102.

Product data provided by the procurement information system 110 may include data related to the features, functionality, and costs of particular products offered by various suppliers. Product data may also include data relating to product cross-references suggested by a third party entity, product cross-references used by other HCOs, spending by other HCOs, responses to questionnaires and assessments related to particular products and product categories, and the like. For example, such product data may include, without limitation, product descriptions, a manufacturer name as known to a procurement provider, a vendor name as known to the procurement provider, a catalog number as known to the procurement provider, a contract price, a product category identifier (e.g., a UNSPSC number or Product Spend Category), packaging information, a Level II HCPCS code, or the like. In some embodiments, the product data received from the procurement information system 110 is also reconciled or mapped with/to product data received from the healthcare information system 108, as described above, in order to generate metrics and analytics for the data stored in the healthcare information system 108. Reconciliation and mapping of data received from the procurement information system 110 with the healthcare information system 108 may, for example, map product identification information provided by the HCO (e.g., supplier name, catalog number, and/or description) to a master list of products maintained by a procurement provider. In some embodiments, a confidence index is generated for this mapping (e.g., a weighted value for how close particular elements of product data match between the HCO and procurement provider), and the mapping is confirmed if the confidence index is greater than a particular threshold value.

### Example Apparatuses for Implementing Embodiments of the Present Invention

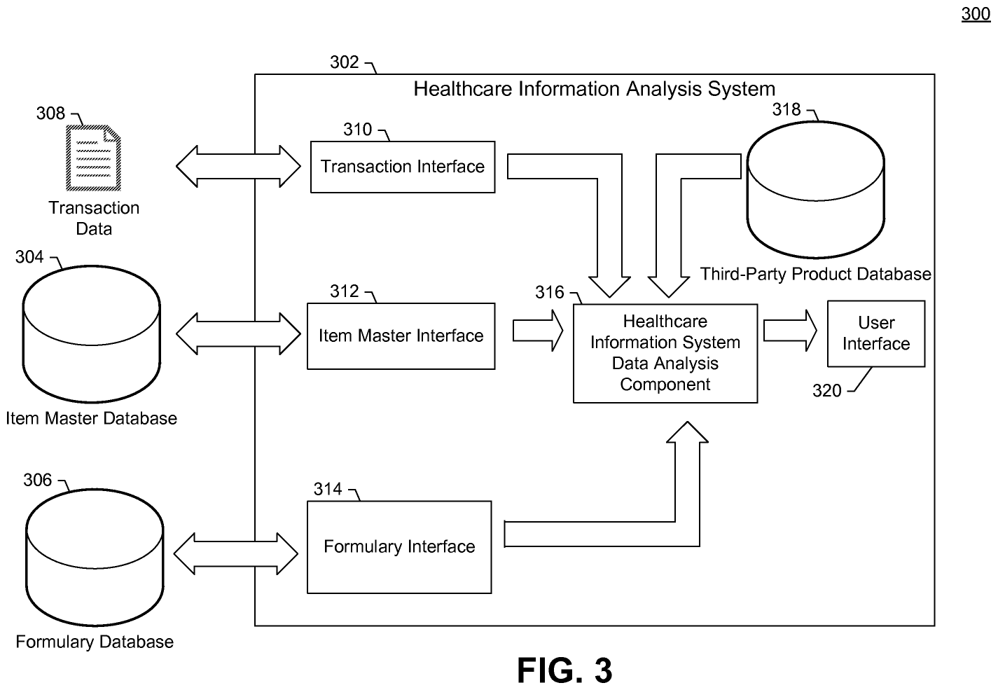

The healthcare information analysis system 102 may be embodied by one or more computing systems, such as apparatus 200 shown in FIG. 2. As illustrated in FIG. 2, the apparatus 200 may include a processor 202, a memory 204, input/output circuitry 206, communications circuitry 208, product management circuitry 210, healthcare information system interface circuitry 212, healthcare information system analysis circuitry 214, and transaction management circuitry 216. The apparatus 200 may be configured to execute the operations described above with respect to FIG. 1 and below with respect to FIGS. 3-12. Although these components 202-216 are described with respect to functional limitations, it should be understood that the particular implementations necessarily include the use of particular hardware. It should also be understood that certain of these components 202-216 may include similar or common hardware. For example, two sets of circuitry may both leverage use of the same processor, network interface, storage medium, or the like to perform their associated functions, such that duplicate hardware is not required for each set of circuitry. The use of the term “circuitry” as used herein with respect to components of the apparatus should therefore be understood to include particular hardware configured to perform the functions associated with the particular circuitry as described herein.

The term “circuitry” should be understood broadly to include hardware and, in some embodiments, software for configuring the hardware. For example, in some embodiments, “circuitry” may include processing circuitry, storage media, network interfaces, input/output devices, and the like. In some embodiments, other elements of the apparatus 200 may provide or supplement the functionality of particular circuitry. For example, the processor 202 may provide processing functionality, the memory 204 may provide storage functionality, the communications circuitry 208 may provide network interface functionality, and the like.

In some embodiments, the processor 202 (and/or co-processor or any other processing circuitry assisting or otherwise associated with the processor) may be in communication with the memory 204 via a bus for passing information among components of the apparatus. The memory 204 may be non-transitory and may include, for example, one or more volatile and/or non-volatile memories. In other words, for example, the memory may be an electronic storage device (e.g., a computer readable storage medium). The memory 204 may be configured to store information, data, content, applications, instructions, or the like, for enabling the apparatus to carry out various functions in accordance with example embodiments of the present invention.

The processor 202 may be embodied in a number of different ways and may, for example, include one or more processing devices configured to perform independently. Additionally or alternatively, the processor may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In an example embodiment, the processor 202 may be configured to execute instructions stored in the memory 204 or otherwise accessible to the processor. Alternatively or additionally, the processor may be configured to execute hard-coded functionality. As such, whether configured by hardware or software methods, or by a combination thereof, the processor may represent an entity (e.g., physically embodied in circuitry) capable of performing operations according to an embodiment of the present invention while configured accordingly. Alternatively, as another example, when the processor is embodied as an executor of software instructions, the instructions may specifically configure the processor to perform the algorithms and/or operations described herein when the instructions are executed.

In some embodiments, the apparatus 200 may include input/output circuitry 206 that may, in tum, be in communication with processor 202 to provide output to the user and, in some embodiments, to receive an indication of a user input. The input/output circuitry 206 may comprise a user interface and may include a display and may comprise a web user interface, a mobile application, a client device, a kiosk, or the like. In some embodiments, the input/output circuitry 206 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 204, and/or the like).

The communications circuitry 208 may be any means such as a device or circuitry embodied in either hardware or a combination of hardware and software that is configured to receive and/or transmit data from/to a network and/or any other device, circuitry, or module in communication with the apparatus 200. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally or alternatively, the communication interface may include the circuitry for interacting with the antenna(s) to cause transmission of signals via the antenna(s) or to handle receipt of signals received via the antenna(s).

The product management circuitry 210 includes hardware configured to retrieve, store, and provide access to information regarding products available to a particular HCO. The product management circuitry 210 may include hardware configured to add, remove, and modify products contained within a healthcare information system, such as an item master. The product management circuitry 210 may also provide access to data related to product cross-references, including product cross-references indicated within a healthcare information system and product cross-references indicated by a procurement information system. The product management circuitry 210 may provide such product data to the healthcare information system analysis circuitry 216 to assist with analysis of data quality of data stored in a healthcare information system and for generation of analytics and metrics related to those healthcare information systems.

In some embodiments, the product management circuitry 210 may also include hardware configured to notify a procurement information system of product data stored on a healthcare information system, such as to enable “crowd-sourcing” of product data from a plurality of healthcare information systems. The product management circuitry 210 may include processing circuitry, such as the processor 202, to perform these functions. The product management circuitry 210 may also include a memory, such as the memory 204 to store product data, and a communications interface, such as the communications circuitry 208 to communicate with the healthcare information system and procurement information system. The product management circuitry 210 is therefore implemented using hardware components of the apparatus configured by either hardware or software for implementing these planned functions.

The healthcare information system interface circuitry 212 includes hardware configured to communicate with one or more healthcare information systems. The healthcare information system interface circuitry 212 may, for example, include hardware configured to obtain electronic records stored in a formulary or item master maintained by a HCO by performing network communications with a healthcare information system. For example, in some embodiments the healthcare information system interface circuitry 212 communicates with a healthcare information system to obtain a list of products in an EDI 832 catalog price file format, as a set of comma separated values (CSV), as an extensible markup language (XML) file, or the like. It should be appreciated that different healthcare information systems may provide data in different formats, and the healthcare information system interface circuitry 212 may be configured to accept such data in each different formats and parse or process such data into a format usable by the healthcare information system analysis circuitry 214. The request management circuitry 212 may include a network interface, such as the communications circuitry 208 for communicating with the healthcare information systems. The healthcare information system interface circuitry 212 may include processing circuitry, such as the processor 202 to perform these communications and to obtain copies of stored data for analysis purposes. The healthcare information system interface circuitry 212 may store electronic data obtained from healthcare information systems in a memory, such as the memory 204. The healthcare information system interface circuitry 212 is therefore implemented using hardware components of the apparatus configured by either hardware or software for implementing these planned functions.

The healthcare information system analysis circuitry 214 analyzes data obtained from healthcare information systems to provide metrics and analytics for the data stored in those systems. This analysis may include reconciling of data obtained from healthcare information systems with data obtained from procurement information systems. The healthcare information system analysis circuitry 214 may include hardware configured to determine the quality of data (e.g., error rates and the like) stored in healthcare information systems and to report on measured data quality. The healthcare information system analysis circuitry 214 may also include hardware configured to generate an interface for viewing metrics and other calculated values for particular products referenced in healthcare information systems. For example, the healthcare information system analysis circuitry 214 may provide a graphical user interface (in conjunction with the input/output circuitry 206 and/or communications circuitry 208) that allows a user to view spending data, product cross-reference information, product attributes (e.g., product names, sizes, categories, descriptions, or the like), product vendor information, and the like for each product referenced within a HCO item master, formulary, charge master, or other product reference system. The healthcare information system analysis circuitry 214 may also provide for indexing and searching of products referenced in data obtained from the healthcare information systems. To this end, the healthcare information system analysis circuitry 214 may receive electronic data from healthcare information systems via the healthcare information system interface circuitry 212, and product data, spending data, and the like from the product management circuitry 210 or the transaction management circuitry 216. It should also be appreciated that, in some embodiments, spending data may also or alternatively be provided by the healthcare information system via the healthcare information system interface circuitry 212, or from various other sources. The healthcare information system analysis circuitry 214 may include processing circuitry, such as the processor 202 to analyze the received data and to provide metrics, analytics, and the like. The healthcare information system analysis circuitry 212 may store generated analytics, metrics, reports, and the like in a memory, such as the memory 204. The healthcare information system analysis circuitry 212 is therefore implemented using hardware components of the apparatus configured by either hardware or software for implementing these planned functions.

The transaction management circuitry 216 includes hardware configured to monitor transactions performed by healthcare information systems, including the purchase of products from suppliers by a HCO. In some embodiments, the transaction management circuitry 216 may monitor transactional traffic data between a healthcare information system and a procurement information system as the HCO orders products from the procurement information system. Alternatively, in some embodiments the transaction management circuitry 216 may receive transactional traffic data information directly from the healthcare information system and/or procurement information system. In yet further embodiments, transactional traffic data may be received in a processed or analyzed format, while in other embodiments the transactional traffic data may be received as raw purchase order data, invoice data, or the like. The transactional traffic data may be received via a network interface, such as the communications circuitry 208. Processing and managing of transactional traffic data may be performed via processing circuitry, such as the processor 202. Transactional traffic data may be stored in a memory, such as the memory 204. The transaction management circuitry 216 is therefore implemented using hardware components of the apparatus configured by either hardware or software for implementing those planned functions.

As will be appreciated, any such computer program instructions and/or other type of code may be loaded onto a computer, processor or other programmable apparatus's circuitry to produce a machine, such that the computer, processor other programmable circuitry that execute the code on the machine create the means for implementing various functions, including those described herein.

It is also noted that all or some of the information presented by example displays described herein can be based on data that is received, generated and/or maintained by one or more components of the apparatus 200. In some embodiments, one or more external systems (such as a remote cloud computing and/or data storage system) may also be leveraged to provide at least some of the functionality discussed herein.

As described above and as will be appreciated based on this disclosure, embodiments of the present invention may be configured as methods, mobile devices, backend network devices, and the like. Accordingly, embodiments may comprise various means including entirely of hardware or any combination of software and hardware.

Furthermore, embodiments may take the form of a computer program product on at least one non-transitory computer-readable storage medium having computer-readable program instructions (e.g., computer software) embodied in the storage medium. Any suitable computer-readable storage medium may be utilized including non-transitory hard disks, CD-ROMs, flash memory, optical storage devices, or magnetic storage devices.

### Example Electronic Marketing Information Service Data Flow

FIG. 3 depicts an example data flow 300 illustrating interactions between healthcare information systems, such as an item master database 304 and a formulary database 306, a healthcare information analysis system 302, and a procurement information system that provides transaction data 308. The healthcare information analysis system 302 may be implemented in the same or a similar fashion as the healthcare information analysis system 102 as described above with respect to FIG. 1 and/or the apparatus 200 described above with respect to FIG. 2.

The data flow 300 illustrates how electronic data may be received and processed by different components of a healthcare information analysis system 302 to generate analytics and metrics for a healthcare information system. The healthcare information analysis system 302 may access healthcare information systems, such as an item master database 304 and a formulary database 306 to obtain copies of one or more data records stored therein for analysis.

The healthcare information analysis system 302 may include interfaces for receiving transaction data 308 in addition to the data from the item master database 304 and the formulary database 306. Data received from the item master database 304 and the formulary database 306 may be provided as a file or files, in response to queries generated by the healthcare information analysis system 302, as responses to application programming interface (API) calls initiated by the healthcare information analysis system 302, or the like. Transaction data 308 may be received from various procurement information systems, such as a procurement information system offered by a supplier or distributor of products, or various other enterprise resource planning or supply chain management systems. The transaction data 308 may include one or more product identifiers (e.g., a product model number, stock keeping unit, universal product code, text name, UNSPSC identifier, or the like), a quantity of the product purchased, a cost at which the product was purchased, terms of a contract under which the product was purchased (e.g., discount terms, market share commitment terms, return policies), or the like as indicated in electronic purchase orders, electronic invoices, or the like. The healthcare information analysis system 302 may monitor traffic between a HCO and such a procurement information system, such as electronic purchase orders created by the HCO and sent to the procurement information system, invoices sent from the procurement information system to the HCO, or the like. As noted above, in some embodiments the transaction data 308 is received by the healthcare information system in a passive manner, by monitoring traffic, while in other embodiments the transaction data 308 is sent directly from the HCO to the healthcare information analysis system 302. In yet further embodiments, the healthcare information analysis system 302 is a component of the procurement information system and receives the transaction data directly from the procurement information system. The healthcare information analysis system 302 includes a variety of interfaces for receiving data for use in generation of metrics and analytics. The healthcare information analysis system 302 may include a transaction interface 310, an item master interface 312, and a formulary interface 314. The transaction interface 310 may be implemented by, for example, transaction management circuitry as described above with respect to FIG. 1, and the item master interface 312 and/or formulary interface 3134 may be implemented by, for example, healthcare information interface circuitry as described above with respect to FIG. 1. Each of the transaction interface 310, the item master interface 312, and the formulary interface 314 may be an electronic network interface for communicating with each respective system, such that the transaction interface 310 communicates with or monitors communications with a procurement information system, the item master interface 312 communicates or monitors communications with an electronic item master database 304, and the formulary interface 314 communicates or monitors communications with a formulary database 316. As described above, data may be provided to the item master interface 312 and the formulary interface 314 as a series of comma separated values, XML files, or the like. In some embodiments, the item master interface 312 and the formulary interface 314 may access the item master database 304 and the formulary database 316 directly to obtain this data and to generate files in the appropriate format (e.g., such that the item master interface 312 and formulary interface 314 generate the CSV or XML files). In some embodiments, the item master database 304 and the formulary database 316 may maintain files stored in the appropriate file formats for use by the item master interface 312 and the formulary interface 314.

The healthcare information analysis system 302 includes a healthcare information system data analysis component 316. The healthcare information system data analysis component 316 receives data from one or more of the transaction interface 310, the item master interface 312, and the formulary interface 314. The received data is analyzed and used to generate analytics and metrics for data stored in the item master database 304, the formulary database 306, and/or other healthcare information systems.

The healthcare information data analysis component 316 may also access a third-party product database 318. The third-party product database 318 may include information about one or more products available for inclusion in the item master database 304, the formulary database 306, and various other healthcare information systems. For example, the third-party product database 318 may include a directory of all products available for purchase through a particular procurement information system, from a particular product supplier, or the like. The third-party product database 318 may index products in a manner that is not tied to any particular HCO system. In this manner, the third-party product database 318 may provide a “neutral” set of product information that is not reliant on regular maintenance by an individual HCO. The third-party product database 318 may be curated by one or more administrators of the healthcare information analysis system 302 or a particular procurement information system. It should be appreciated that the use of “third-party” in this contexts merely refers to the fact that the third-party product database 318 is external to a particular HCO. The third-party product database 318 may therefore be included within the healthcare information analysis system 302 and/or maintained by the healthcare information analysis system 302. Alternatively, the third-party product database 318 may be stored on or maintained by a system external to the healthcare information analysis system 302, such as an external procurement information system operated by a product supplier or any other system or systems in communication with the healthcare information analysis system 302.

The healthcare information system data analysis component 316 may generate a variety of metrics and analytics. For example, the healthcare information system data analysis component 316 may map records associated with products stored in the item master database 304 and/or formulary database 306 to one or more unique product identifiers identified in the third-party product database 318. If more than one record of the item master database 304 or the formulary database 306 maps to the same unique product identifier, than the respective records of the item master database 304 or the formulary database 306 may be identified as duplicate records and flagged for review. As another example, the healthcare information system data analysis component 316 may determine that a product identified in the formulary database 306 maps to a unique identifier of a product that is discontinued or otherwise no longer available from a supplier. Upon identification of such a product, the healthcare information system data analysis component 316 may flag the record for replacement, suggest a cross-reference product to the discontinued product, or the like. In some embodiments, the healthcare information system data analysis component 316 may calculate a “data quality score” or other numeric representation of the overall quality of data stored in a healthcare information system such as the item master database 304 or the formulary database 306. Such a score may be calculated by applying a formula that includes weighted values identifying the number of duplicate records, obsolete records, the total number of records in the database (e.g., to calculate a percentage of records in error), and the like. In some embodiments, such a score may also incorporate characteristics of particular products or records, such as the cost of particular products identified in the respective databases, product quality ratings associated with records identified in the respective databases, and the like. It should be appreciated that a variety of weights could be applied to different factors for use in calculation of a data quality score, such that different weights could be chosen depending upon which factors the user chooses to emphasize in providing an evaluation of the quality of records stored in the healthcare information system.

The healthcare information system data analysis component 316 may also generate metrics specific to particular healthcare information systems. For example, the healthcare information system data analysis component 316 may evaluate products identified within the formulary database 306 against the transaction data 308 to determine the frequency with which products that are “off formulary” are purchased. In this manner, embodiments may provide HCOs with the ability to assess whether and how the list of products identified in the formulary database are meeting the needs, such that the HCO can determine if policy changes are needed to encourage practitioners to stick to the formulary products, or if new products should be added or removed from the formulary. Embodiments may also provide cost analysis comparing products listed in the formulary to cross-references for those products.

The healthcare information system data analysis component 316 may also provide for review and access of the data records stored within analyzed healthcare information systems. For example, the healthcare information system data analysis component 316 may index products listed within the healthcare information systems with spending data associated with those products as identified by the transaction data 308.

The healthcare information system data analysis component 316 may generate a user interface 320 to provide access to the generated analytics and metrics. The user interface 320 may be any sort of graphical user interface as known in the art, such as a web-based interface hosted on a remote server, a client application executing on a user device, an interface displayed on a monitor or other display device coupled to the healthcare information analysis system 302, or the like. The user interface 320 may also provide interface controls allowing the user to provide input to view particular records from the healthcare information systems as reconciled with transaction data (e.g., to see HCO spending data for particular products), to view a list of formulary products, to view products identified in an item master database, or the like. In some embodiments, the user interface 320 may also be employed to control the selection and/or generation of particular metrics and analytics. For example, the user interface 320 may allow for selection of particular health information systems for analysis (e.g., if a user has access to more than one item master or formulary, such as in the case where a single HCO has multiple facilities with separate healthcare information systems). The user interface 320 may also provide the capability to modify weights, thresholds, or other parameters associated with metric calculation, such as, for example, a selectable impact of different factors to influence a data quality score.

### Exemplary Interfaces

FIGS. 4-10 illustrate exemplary interfaces for providing healthcare information system analysis using a healthcare information analysis system in accordance with exemplary embodiments of the present invention. The interfaces depicted in FIGS. 4-10 may be provided by a healthcare information analysis system in a variety of manners. For example, the healthcare information analysis system may provide a web-based interface allowing users to interact with the healthcare information analysis system via a web browser. The interfaces may, for example, be provided as user interfaces 320 as described above with respect to FIG. 3.

FIG. 4 illustrates an interface 400 that provides the results of an analysis of an item master database. The interface 400 includes a content summary 402, a metrics summary 404, and a data quality analysis 406. The content summary 402 provides a description of the contents of the item master database, such as the number of products, a list of attributes associated with particular products, contact information for administrators of the item master database, and the like.

The metrics summary 404 provides a list of metrics resulting from an analysis of the item master database. The metrics summary 404 in the instant case indicates the number of products identified in the item master database, the number of unavailable or “non-stock” products (e.g., products that are known in the item master but not stocked in inventory by the HCO), the number/percentage of products available through a particular procurement information system (e.g., via contracts offered by Novation), the number/percentage of products of the item master which are the subject of active spending (e.g., products that have been purchased within a particular time period), and the number of new products added within a predefined time period. It should be appreciated that some of these metrics, such as the number of products with active spending, may be determined at least in part using both data from the item master database and transaction data that identifies which products have been purchased, the cost at which they were purchased, and the like.

The data quality analysis 406 includes an interface control (e.g., a line graph as illustrated in the interface 400) that depicts a numeric value or values that describe the quality of data included in the item master database being analyzed. In the present example, the data quality analysis 406 provides a graph of a percentage (e.g., a score) assigned to the quality of the data stored in an analyzed item master. The data quality analysis 406 may be derived based on identification of relevant factors within the analyzed item master. For example, the present example lists duplicate products, candidate products to inactivate (e.g., products that are duplicates or no longer available), candidate products to add or activate (e.g., products offered by suppliers but which are not included in the item master database), and a number of rogue purchase orders as factors that influence the score assigned to the item master database being analyzed. The term “rogue purchase order” may refer to manually generated purchase orders for products that are included in an item master database or formulary database, but not generated using a materials management system (e.g., an electronic system that interfaces with the item master and/or formulary). Such purchase orders may result in ordering information being inadequately or improperly logged or stored, making it difficult or impossible to use such purchase orders to manage organizational spending (e.g., a manually generated purchase order may not be processed through spending tracking systems or the purchase order may not include sufficient data for proper spending tracking or metric gathering purposes). Accordingly, such rogue purchase orders indicate a problem somewhere in the supply chain process, as orders for products included in the item master and/or formulary should typically be generated using the materials management system. It should be appreciated that these and various other factors may be employed to calculate a data quality score, which may be a numeric value offered on an arbitrary scale (e.g., 0-100, 0-1000, 60-100, 1-10, or the like).

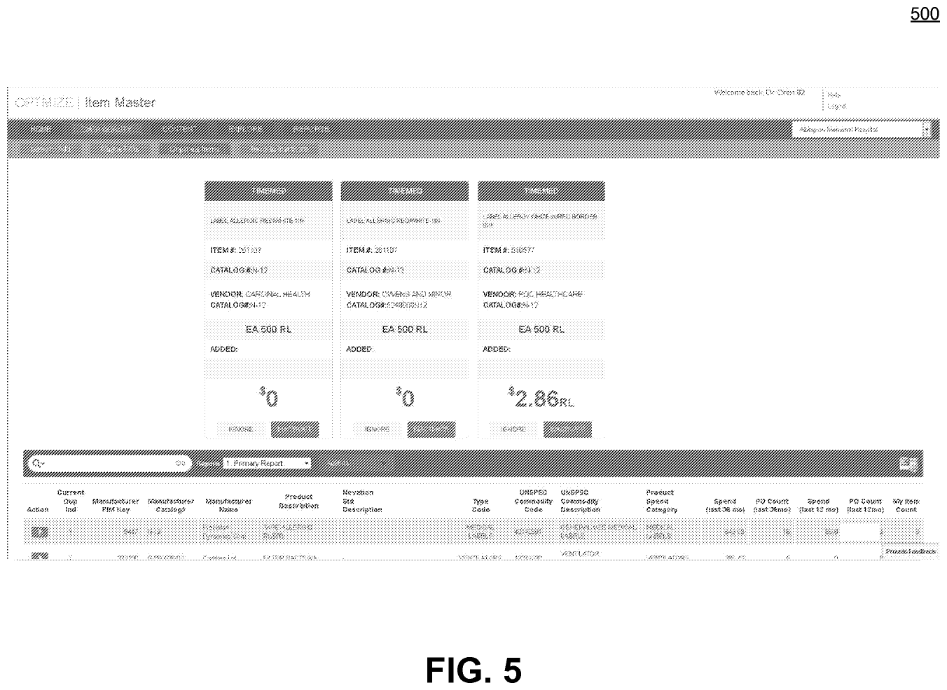

FIG. 5 illustrates an interface 500 for viewing products within an item master that have been identified as potential duplicates in accordance with some example embodiments. As noted above, embodiments are capable of identifying duplicate products in an item master database or other database by various techniques, including identification of products with the same unique identifiers or identification of products which map to the same unique identifier in a third-party database. Once these records are identified, they may be presented to a user via an interface 500 to allow the user to examine the products to determine whether the products are truly duplicate entries and to possibly deactivate those duplicate records within the item master or other database. The interface 500 illustrates three records from an item master that have been identified as potential duplicates, and provides the user with interface controls to deactivate one or more of the records. Upon selection of the appropriate interface control (labeled “inactivate” in the present illustration), the associated record may be deactivated or otherwise removed from the item master. In this manner, embodiments may propagate changes to analyzed healthcare information systems such as item masters in order to improve the quality of data records stored therein. Providing an interface in this manner allows a user to evaluate whether records have been properly identified as duplicates, such that records with similar names or identifiers (e.g., two suppliers using the same identifier for different products) but which are otherwise distinct are not erroneously removed.

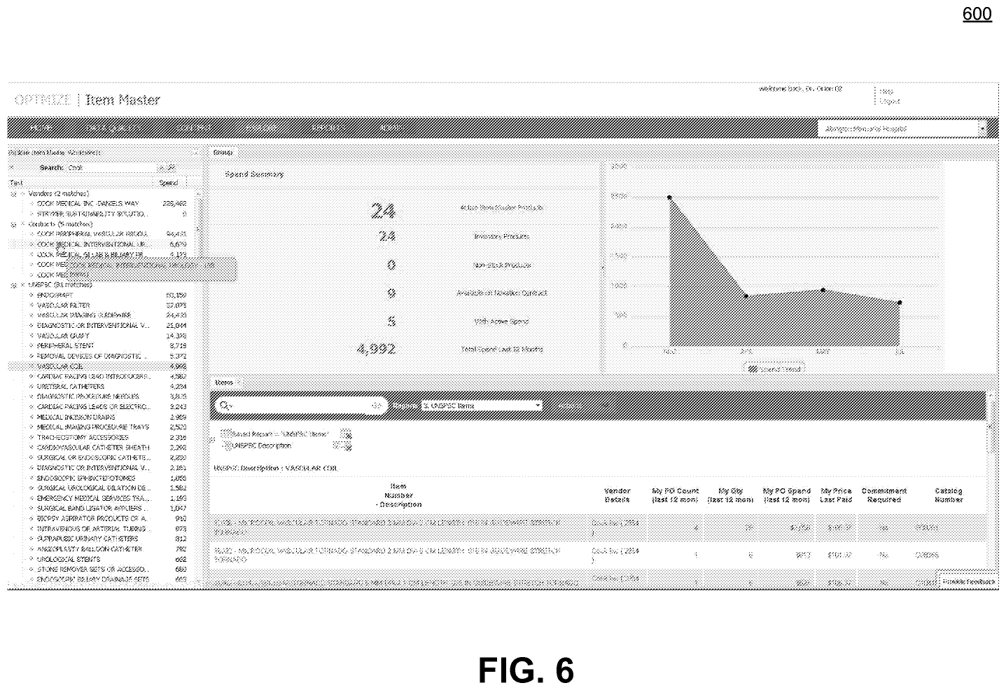

FIG. 6 illustrates an interface 600 that provides the ability to “explore” an item master and review the data for products stored therein. The interface 600 also provides the capability to view spending and other transaction data associated with products listed in an item master database. For example, the interface provides the capability to search through and/or select a product identified in an item master (e.g., using the selection menu disposed along the left side of the interface), and be presented with relevant spending data derived from transactions including the selected product (e.g., purchase orders or invoices including that product). Embodiments may provide a variety of mechanisms for sorting and categorizing products within the item master, including providing search results organized by product, category, vendor, UNSPSC, or the like. The interface 600 may also provide data about spending over time and other spending metrics as derived from the transaction information associated with the selected product. Embodiments may also provide for identification of vendors that offer the product, the current price of the product, functional attributes of the product (e.g., color, size, shape), and the like within the interface.

In particular, the interface 600 depicts a selected product “group”, that of “vascular coils.” Accordingly, the interface 600 depicts spending data for all products within the “vascular coil” UNSPSC that are also listed in the item master. The interface 600 also indicates the number of products in the item master in that category, the number with active spending, the number available through a particular procurement provider, and the like. Such data may be aggregated and generated by a healthcare analysis system as described above with respect to FIGS. 1-3.

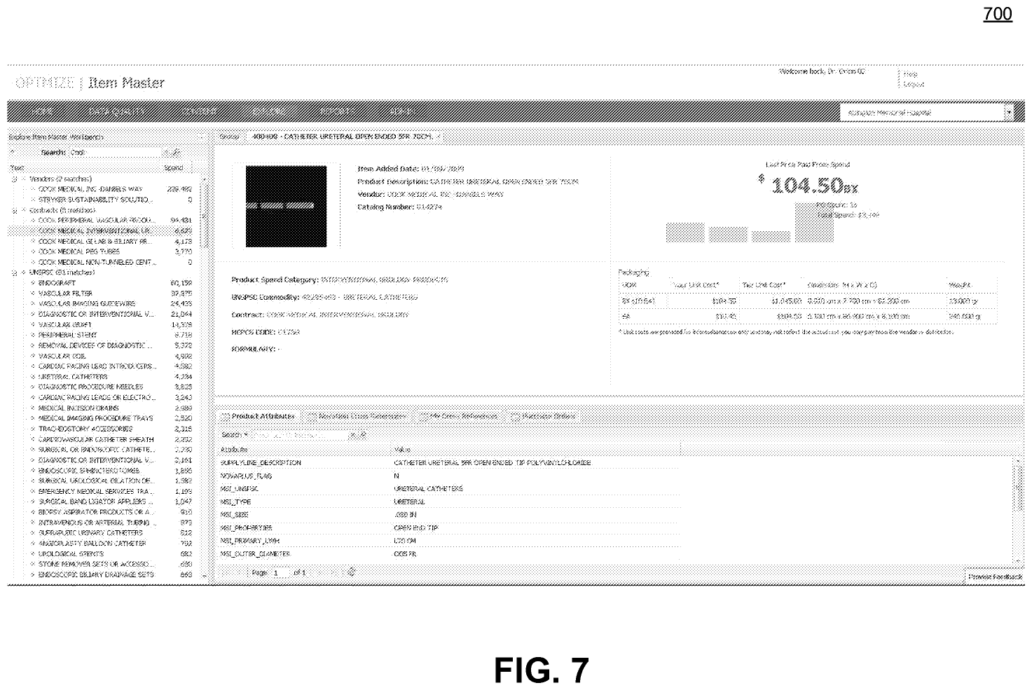

FIG. 7 illustrates an interface 700 that reconciles products from an item master database with a particular contract. As indicated above, transaction information may be received from a variety of sources and in a variety of formats, including information about particular procurement contracts. Such contracts may pertain to particular products purchased by a particular HCO from a particular vendor. Embodiments may associate transaction data from these products with the associated products in the item master, and provide the contract as a selectable control or search result in addition to the products themselves. In this manner, embodiments provide for automatic categorization of products in the item master into a set of contracts that may optionally be selected by a user to view relevant spend data for those products as purchased under the particular contract.

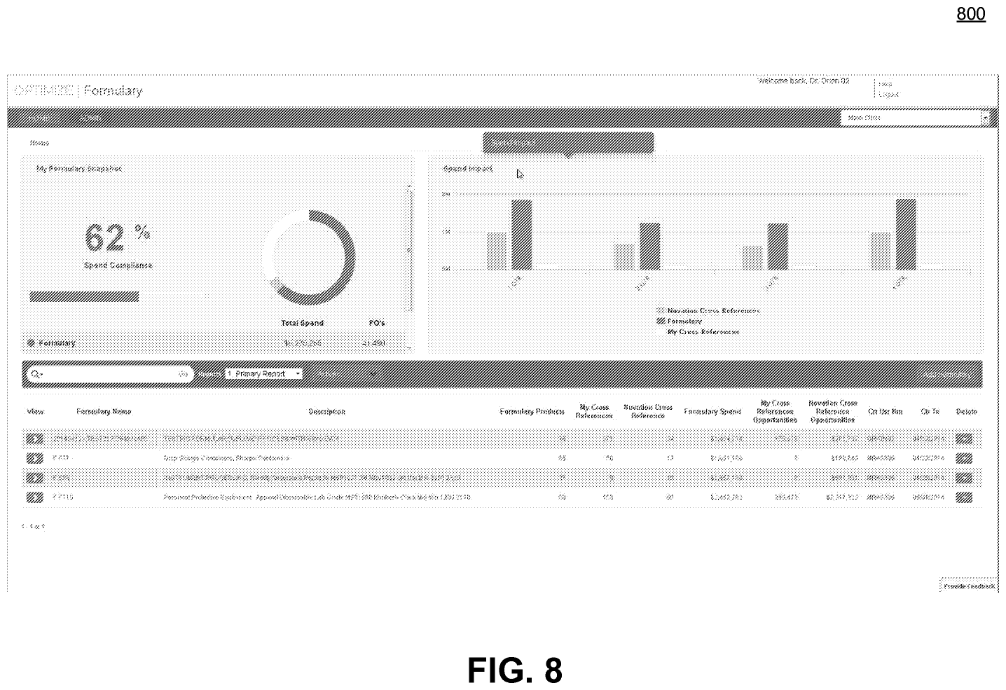

FIG. 8 illustrates an interface 800 for accessing analytics and metrics related to a formulary database. The interface 800 provides a mechanism for displaying the results of an analysis of data included in a HCO formulary database to evaluate the overall quality of the formulary database. In particular, the interface 800 illustrates how embodiments of the present invention reconcile products listed in a formulary database with transaction data and cross-reference data from a third-party product database to identify what percentage of HCO spending is performed on formulary products, opportunities for adding new products to a formulary database, and the impact on overall spending from use (or lack thereof) of formulary products.

In particular, the interface 800 includes a snapshot of spend compliance (e.g., the percentage of the time that formulary products are used as compared to off-formulary products), the impact of the use of formulary products on spending, and an interface for searching and selecting particular products included in the formulary database. The interface 800 may also include interface controls for displaying search results and selecting particular products for a detailed view of formulary information, associated spend data derived from transaction data, and the like. Embodiments may also display the projected spend impact from substitution of cross-referenced products for particular products, for products across the entire formulary, and the like.

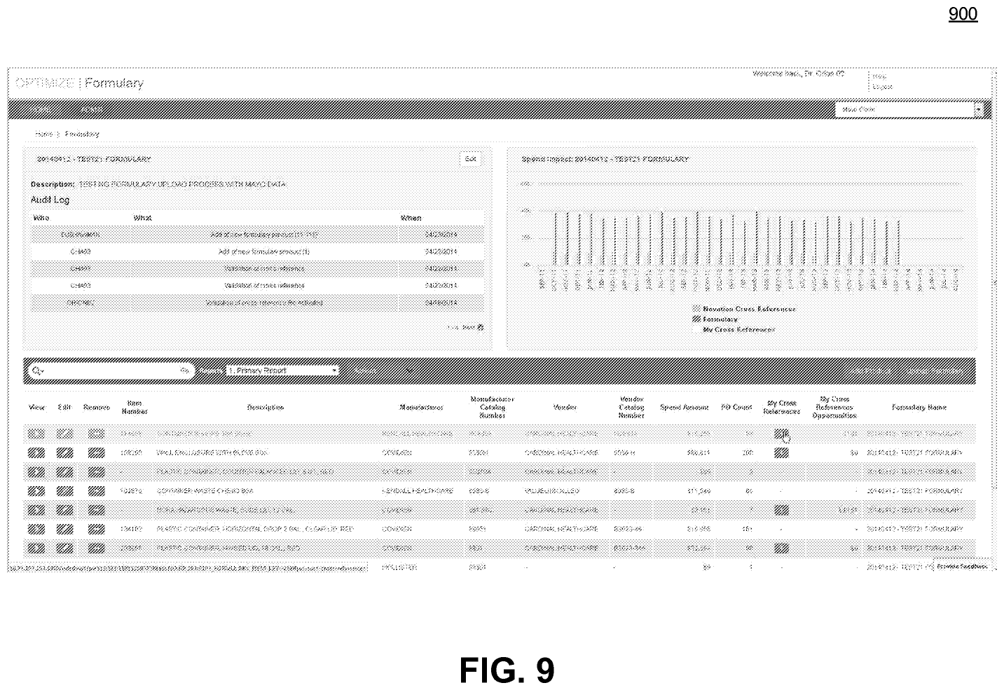

FIG. 9 illustrates an alternative interface 900 for viewing formulary data, which includes an audit log that shows changes, additions, and deletions to the formulary database or products, cross-references, and the like. The interface 900 also provides controls for editing the formulary database by adding or removing products, cross-references, and the like, and for pushing those changes to the formulary database. The interface 900 also displays metrics for products or product cross-references included in the formulary database, such as the number of times the product has appeared in a purchase order, the spending associated with the particular product, the vendor of the product, or the like.

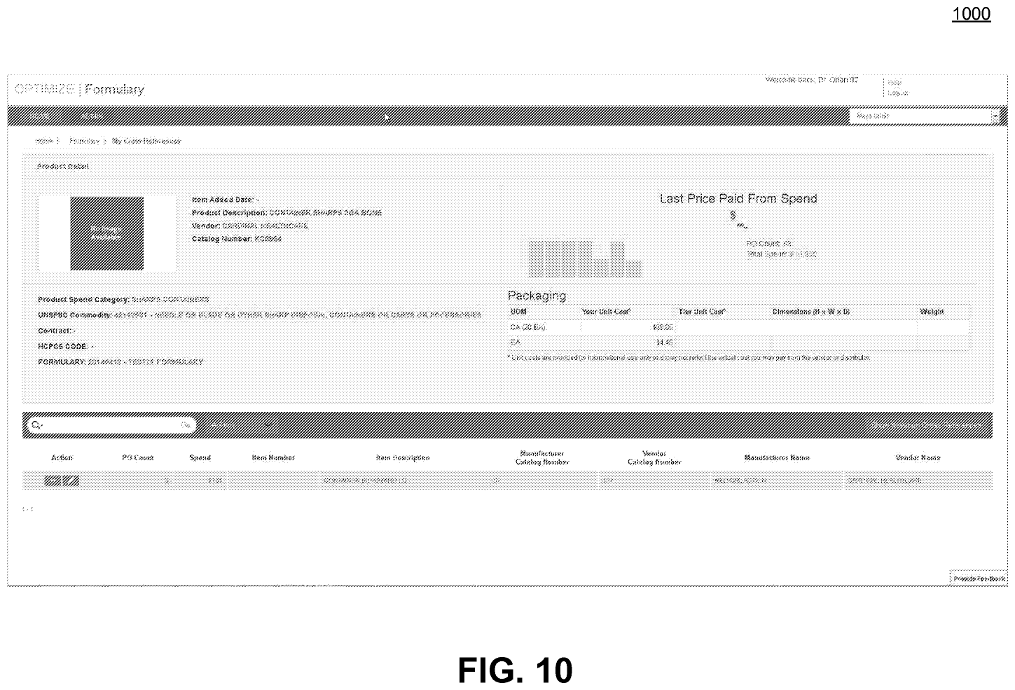

FIG. 10 illustrates an interface 1000 for viewing and editing product cross-references within a formulary. The interface 1000 may employ the use of a third-party product database to identify valid cross-references for products in a formulary database and provide interface controls that cause those cross-references to also be added to the formulary database. The interface 1000 may, for example, provide an indication of the cost savings associated with directing spend to a product cross-reference instead of the formulary product.

### Exemplary Processes for Implementing a Healthcare Information Analysis

FIGS. 11-12 illustrate flow diagrams depicting processes for implementing the healthcare information analysis system described above with respect to FIGS. 1-10 to perform analysis of healthcare information systems in accordance with exemplary embodiments of the present invention. As noted above, embodiments provide for programmatic analysis of various healthcare information systems such as electronic formularies and electronic item masters by evaluating the quality of data stored in those healthcare information systems. Embodiments also review products identified in these systems and assist users with determining whether to add or remove products from these healthcare information systems by reconciling products identified in the systems with transaction data and third-party product data as indicated above. To this end, embodiments advantageously provide for improved mechanisms for programmatically updating and maintaining these healthcare information systems.

FIG. 11 illustrates a flow diagram depicting an example of a process 1100 for reviewing data stored in an electronic item master in accordance with embodiments of the present invention. As described above, embodiments may examine electronic item masters to generate metrics and analytics to be used to improve and maintain the quality of data stored in said electronic item masters. The process 1100 illustrates one example of a mechanism for performing these functions. The process 1100 may be performed by a healthcare information analysis system, such as apparatus 200 described above with respect to FIG. 2.

At action 1102, item master data for an HCO is accessed. The item master data may be indexed by a series of identifiers that are specific to the particular HCO or otherwise presented in a non-organization-agnostic format. At action 1104, organization-agnostic identifiers are determined for the products identified in the item master data, such as by mapping products listed in the item master data to products identified in a third-party product database. At action 1106, transaction data for the HCO is received. As noted above, the transaction data may be received from a variety of sources, including the HCO itself, by monitoring traffic between the HCO and a procurement information system, from a procurement information system directly, or the like. At action 1108, organization-agnostic identifiers are determined for the products identified in the transaction information.

At action 1110, the products in the item master are reconciled with the transaction data by matching the organization-agnostic product identifiers. Mapping the item master products to the transaction data allows for the measurement and calculation of spend data for products indicated in the item master. At action 1112, metrics are calculated for the item master data. These metrics may include, for example, quality measurements for the data stored in the item master (e.g., number of duplicate entries, number of “non-stock” entries, number of obsolete entries), spending metrics (e.g., spend on each product listed in the item master), available product cross-references indicated by third-party product data, or the like. These metrics and other analytics may be presented by an interface, such as the interfaces described above with respect to FIGS. 3-7, and presented to one or more users, used to generate reports, or the like. It should be appreciated that the metrics generated by the process 1100 may be any of the metrics as described above, and that in some embodiments such metrics may not require reconciliation of spending data with the item master data (e.g., such as in the case where the metrics involve only identification of duplicate entries), while in other embodiments the metrics may be generated from a combination of multiple calculated values, such as through the use of a formula that calculates an arbitrary numeric value representing the overall quality of the item master data.

FIG. 12 illustrates a flow diagram depicting a process 1200 for generating formulary metrics in accordance with some embodiments of the present invention. As noted above, embodiments may assist with viewing, accessing, editing, and evaluating product data stored in a formulary database. Generation of this data may include receiving and analyzing information received from a variety of sources, including but not limited to an HCO formulary database, product transaction data, and third-party product databases. These metrics may include metrics that indicate how closely HCO product purchasing tracks to identified formulary products, the amount of savings available from using cross-reference products for formulary products, and the like. The process 1200 illustrates one example of a mechanism for performing these functions. The process 1200 may be performed by a healthcare information analysis system, such as apparatus 200 described above with respect to FIG. 2.

At action 1202, the process receives data from an HCO formulary database, HCO transaction information, and product cross-reference information. In some embodiments, a mapping of HCO-specific product identifiers to HCO-agnostic product identifiers may occur, as described above with respect to FIGS. 3 and 11. The HCO formulary database may include a set of data identifying products listed in the formulary database. The HCO transaction information may include electronic transaction information such as purchase orders, invoices, and the like as described above. The product cross-reference information may include a list of cross-references between products as identified in a third-party product database as described above.

At action 1204, cross-references that apply to products identified in the formulary data may be identified. At action 1206, the transaction data and the cross-reference data is used to determine the impact on spending from using one or more cross-reference products for products identified in the formulary data. At action 1208, formulary metrics may be generated using, for example, the spending impact identified at action 1206. These metrics may include an indication of possible cost savings from adding additional products to the formulary or switching from products currently included in the formulary to cross-references products for those products. At action 1210, the generated formulary metrics are presented via an interface, such as a user interface as described above with respect to FIGS. 7-10.

As will be appreciated, computer program code and/or other instructions may be loaded onto a computer, processor or other programmable apparatus's circuitry to produce a machine, such that execution of the code on the machine by the computer, processor, or other circuitry creates the means for implementing various functions, including those described herein.

As described above and as will be appreciated based on this disclosure, embodiments of the present invention may be configured as methods, mobile devices, backend network devices, and the like. Accordingly, embodiments may comprise various means including entirely of hardware or a combination of software and hardware. Furthermore, embodiments may take the form of a computer program product on at least one computer-readable storage medium having computer-readable program instructions (e.g., computer software) embodied in the storage medium. Any suitable computer-readable storage medium may be utilized, including non-transitory hard disks, CD-ROMs, flash memory, optical storage devices, magnetic storage devices, or the like.

Embodiments of the present invention have been described above with reference to block diagrams and flowchart illustrations of methods, apparatuses, systems and computer program products. It will be understood that each block of the circuit diagrams and process flowcharts, and combinations of blocks in the circuit diagrams and process flowcharts, respectively, can be implemented by various means including computer program instructions. These computer program instructions may be loaded onto a general purpose computer, special purpose computer, or other programmable data processing apparatus to produce a machine, such that the computer program product includes the instructions which execute on the computer or other programmable data processing apparatus create a means for implementing the functions specified in the flowchart block or blocks.

These computer program instructions may also be stored in a computer-readable storage device that can direct a computer or other programmable data processing apparatus to function in a particular manner, such that the instructions stored in the computer-readable storage device produce an article of manufacture including computer-readable instructions for implementing the function discussed herein. The computer program instructions may also be loaded onto a computer or other programmable data processing apparatus to cause a series of operational steps to be performed on the computer or other programmable apparatus, thereby producing a computer-implemented process such that the instructions executed on the computer or other programmable apparatus cause performance of the steps and thereby implement the functions discussed herein.

Accordingly, blocks of the block diagrams and flowchart illustrations support combinations of means for performing the specified functions, combinations of steps for performing the specified functions and program instruction means for performing the specified functions. It will also be understood that each block of the circuit diagrams and process flowcharts, and combinations of blocks in the circuit diagrams and process flowcharts, can be implemented by special purpose hardware-based computer systems that perform the specified functions or steps, or combinations of special purpose hardware and computer instructions.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

We claim:

1. A healthcare information analysis system for improving the speed of database accesses comprising:
one or more computers comprising one or more processors and one or more non-transitory computer readable media, the one or more non-transitory computer readable media comprising instructions stored thereon that when executed by the one or more processors configure the healthcare information analysis system to:
monitor electronic purchases of products by a healthcare organization (HCO);
receive data regarding one or more products available for purchase by the HCO via electronic communication with a healthcare information system,
map each of the one or more products to a HCO-agnostic product identifier;
identify at least one duplicate entry within the healthcare information system based at least in part on two or more of the one or more products mapping to the same HCO-agnostic product identifier;
analyze the healthcare information system to identify one or more metric items comprising a number of duplicate entries, a number of non-stock entries, amount spent on the one or more products, and/or available product cross-references; and
calculate metrics for the healthcare information system based on the one or more metric items.

2. The healthcare information analysis system of claim 1,
wherein the one or more processors further configure the healthcare information analysis system to:
receive formulary data from the healthcare information system; and
generate formulary metrics by comparing HCO spending data to a set of external product data to identify formulary products as candidates to be added or removed from the healthcare information system.

3. The healthcare information analysis system of claim 1,
wherein the healthcare information analysis system is configured to accept formatted data in different formats and parse or process the formatted data into a format usable by the healthcare information analysis system.

4. The healthcare information analysis system of claim 1,
wherein the one or more processors further configure the healthcare information analysis system to:
generate HCO spending metrics comprising spending activity using electronic data stored in the healthcare information system.

5. The healthcare information analysis system of claim 4,
wherein generating spending metrics comprises comparing a spending amount on products identified in the healthcare information system to a total spending amount by the HCO.

6. The healthcare information analysis system of claim 1,
wherein the one or more processors further configure the healthcare information analysis system to:
propagate a deactivation of the one or more products in the healthcare information analysis system to the healthcare information system.

7. The healthcare information analysis system of claim 1,
wherein the one or more processors further configure the healthcare information analysis system to:
display a user interface;
wherein the user interface comprises a content summary, a metrics summary, and a data quality analysis.

8. A healthcare information analysis system for improving the speed of database accesses comprising:
one or more computers comprising one or more processors and one or more non-transitory computer readable media, the one or more non-transitory computer readable media comprising instructions stored thereon that when executed by the one or more processors configure the healthcare information analysis system to:
monitor electronic purchases of products by a healthcare organization (HCO);
receive data regarding one or more products available for purchase by the HCO via electronic communication with a healthcare information system,
map each of the one or more products to a HCO-agnostic product identifier;
identify at least one duplicate entry within the healthcare information system based at least in part on two or more of the one or more products mapping to the same HCO-agnostic product identifier;
generate a user interface comprising interface controls configured to deactivate one or more of the one or more products;
propagate a deactivation of the one or more products in the healthcare information analysis system to the healthcare information system.

9. The healthcare information analysis system of claim 8,
wherein the one or more processors further configure the healthcare information analysis system to:
generate HCO spending metrics comprising spending activity using electronic data stored in the healthcare information systems.

10. The healthcare information analysis system of claim 9,
wherein generating spending metrics comprises comparing a spending amount on products identified in the healthcare information system to a total spending amount by the HCO.

11. The healthcare information analysis system of claim 8,
wherein the one or more processors further configure the healthcare information analysis system to:
receive formulary data from the healthcare information system; and
generate formulary metrics by comparing HCO spending data to a set of external product data to identify formulary products as candidates to be added or removed from the healthcare information system.

12. The healthcare information analysis system of claim 8,
wherein the healthcare information analysis system is configured to accept formatted data in different formats and parse or process the formatted data into a format usable by the healthcare information analysis system.

13. The healthcare information analysis system of claim 8,
wherein the one or more processors further configure the healthcare information analysis system to:
display a user interface;
wherein the user interface comprises a content summary, a metrics summary, and a data quality analysis.

14. The healthcare information analysis system of claim 8,
wherein the one or more processors further configure the healthcare information analysis system to:
analyze the healthcare information system to identify one or more metric items comprising a number of duplicate entries, a number of non-stock entries, amount spent on the one or more products, and/or available product cross-references; and
calculate metrics for the healthcare information system based on the one or more metric items.

15. A healthcare information analysis system for improving the speed of database accesses comprising:
one or more computers comprising one or more processors and one or more non-transitory computer readable media, the one or more non-transitory computer readable media comprising instructions stored thereon that when executed by the one or more processors configure the healthcare information analysis system to:
monitor electronic purchases of products by a healthcare organization (HCO);
receive data regarding one or more products available for purchase by the HCO via electronic communication with a healthcare information system;
map each of the one or more products to a HCO-agnostic product identifier;
identify at least one duplicate entry within the healthcare information system based at least in part on two or more of the one or more products mapping to the same HCO-agnostic product identifier; and
display a user interface;
wherein the user interface comprises a content summary, a metrics summary, and a data quality analysis.

16. The healthcare information analysis system of claim 15,
wherein the one or more processors further configure the healthcare information analysis system to:
analyze the healthcare information system to identify one or more metric items comprising a number of duplicate entries, a number of non-stock entries, amount spent on the one or more products, and/or available product cross-references; and
calculate metrics for the healthcare information system based on the one or more metric items.

17. The healthcare information analysis system of claim 16,
wherein the one or more processors further configure the healthcare information analysis system to:
propagate a deactivation of the one or more products in the healthcare information analysis system to the healthcare information system.

18. The healthcare information analysis system of claim 17,
wherein the one or more processors further configure the healthcare information analysis system to:
receive formulary data from the healthcare information system; and
generate formulary metrics by comparing HCO spending data to a set of external product data to identify formulary products as candidates to be added or removed from the healthcare information system.

19. The healthcare information analysis system of claim 18,
wherein the one or more processors further configure the healthcare information analysis system to:
generate spending metrics comprising spending activity using electronic data stored in the healthcare information systems.

20. The healthcare information analysis system of claim 19,
wherein generating spending metrics comprises comparing a spending amount on products identified in the healthcare information system to a total spending amount by the HCO.
